(19) United States
(12) Patent Application Publication
(10) Pub. No.: US 2023/0095866 A1
(43) Pub. Date: Mar. 30, 2023

(54) COMPOSITE AND METHOD FOR PREPARING SAME

(71) Applicant: Ki Tai JANG, Hwaseong-si (KR)

(72) Inventors: Ki Tai JANG, Hwaseong-si (KR); Chan Hong PARK, Cheongju-si (KR)

(73) Assignee: Ki Tai JANG, Hwaseong-si (KR)

(21) Appl. No.: 17/994,033

(22) Filed: Nov. 25, 2022

Related U.S. Application Data
(63) Continuation of application No. PCT/KR2021/009185, filed on Jul. 16, 2021.

(30) Foreign Application Priority Data
Sep. 1, 2020 (KR) 10-2020-0110939

(51) Int. Cl. C09C 3/00; C09C 1/24; C09C 1/62; C09C 3/06; C09C 3/08; B22F 1/102; B22F 1/16

(52) U.S. Cl. CPC C09C 3/006; C09C 1/24; C09C 1/62; C09C 3/063; C09C 3/08; B22F 1/102; B22F 1/16; C01P 2004/84; C01P 2004/03; B22F 2301/35

(57) ABSTRACT

The present invention relates to a composite and a manufacturing method thereof, wherein the composite includes a base powder, an adhesive disposed on the surface of the base powder, and functional particles disposed on the adhesive, wherein the adhesive includes at least one of a fatty primary monoamide and a fatty secondary monoamide.

### TECHNICAL FIELD

The present invention relates to a composite and a manufacturing method thereof.

### BACKGROUND ART

Composites, powder-type composites in particular, have been used in various fields. Various composites are used in the powder metallurgy industry, and such composites are manufactured by using metal powders and/or non-metal powders with different sizes and/or specific gravity, and for the purpose of increasing physical, electrical and chemical properties, the composites are manufactured by mixing not only nanopowders such as graphene, carbon nanotubes, fumed silica, and the like, but also a titanium carbide (TiC), a yttrium oxide (Y2O3), a zirconium oxide (Zr2ZrO3), and the like.

However, when there is a difference in sizes and/or specific gravity of the metal powders and/or the non-metal powders, industrial application of the composites is hard to achieve due to segregation, aggregation of powders, and dusting of powders. In some cases, examples of increasing tensile strength, hardness, and electrical properties by using a wet method or a ball mill method have been reported, but the examples are still applicable only to small-volume production, and are not widely used due to high manufacturing cost and low productivity.

US Patent Publication No. 5854966, which is a prior art document, discloses a method for mixing a metal powder and a non-metal powder using a ball mill.

### DISCLOSURE OF THE INVENTION

### Technical Problem

An object of the present invention is to provide a composite having various functional particles which are disposed on the surface thereof. In addition, the present invention provides a method for manufacturing a composite, the method capable of efficiently manufacturing a composite using various base powders and functional particles.

In addition, it is possible to stably manufacture a composite without segregation or aggregation and dusting of powders.

In addition, it is possible to manufacture a composite in which functional particles are uniformly disposed on a base powder.

### Technical Solution

A composite according to an embodiment of the present invention includes a base powder, an adhesive disposed on the surface of the base powder, and functional particles disposed on the adhesive, wherein the adhesive includes at least one of a fatty primary monoamide and a fatty secondary monoamide.

The adhesive may have a melting point of 120° C. or less.

The adhesive may include at least one of oleamide, erucamide, or stearamide.

A method for manufacturing a composite according to an embodiment of the present invention includes the step of: preparing a base powder; dissolving an adhesive in a solvent to prepare an adhesive solution; disposing the adhesive solution on the surface of the base powder; removing the solvent from the adhesive solution to dispose the adhesive on the base powder; and disposing functional particles on the adhesive, wherein the adhesive includes at least one of a fatty primary monoamide and a fatty secondary monoamide.

The step of removing the solvent from the adhesive solution to dispose the adhesive on the base powder may include a step of heating the adhesive solution to a temperature equal to or lower than the melting point of the adhesive to crystallize the adhesive.

A method for manufacturing a composite according to another embodiment of the present invention includes the steps of: mixing a base powder and an adhesive; and generating frictional heat between the base powder and the adhesive, wherein the adhesive includes at least one of a fatty primary monoamide and a fatty secondary monoamide.

The step of generating frictional heat between the base powder and the adhesive may include a step of heating the mixture of the base powder and the adhesive to a temperature equal to or lower than the melting point of the adhesive.

A method for manufacturing a composite according to an embodiment of the present invention includes the steps of: preparing a base powder; heating an adhesive to a temperature equal to or higher than the melting point thereof; disposing the adhesive on the surface of the base powder; and disposing functional particles on the adhesive, wherein the adhesive includes at least one of a fatty primary monoamide and a fatty secondary monoamide.

The step of disposing functional particles on the adhesive may include a step of heating the adhesive to a temperature equal to or lower than the melting point of the adhesive.

### Advantageous Effects

A composite according to an embodiment of the present invention may have various functional particles disposed on the surface thereof. In addition, a method for manufacturing a composite according to an embodiment of the present invention may efficiently manufacture a composite using various base powders and functional particles.

In addition, it is possible to stably manufacture a composite without segregation or aggregation and dusting of powders by using homogeneous or heterogeneous powders and particles.

In addition, it is possible to manufacture a composite in which functional particles are uniformly disposed on a base powder.

In addition, it is possible to manufacture a composite without using toxic substances.

### BRIEF DESCRIPTION OF THE DRAWINGS

FIG. 1 to FIG. 3 illustrate a composite according to an embodiment of the present invention.

FIG. 4 to FIG. 9 are photographs taken by SEM of a composite manufactured according to a method for manufacturing a composite according to an embodiment of the present invention.

The description of the reference numerals in the drawings is as follows.

1, 4, 6, 8, 10, 12, 14, 16: Base powder

2, 5, 7, 17: Adhesive

3, 9, 11, 13, 15: Functional particles

### MODE FOR CARRYING OUT THE INVENTION

Hereinafter, preferred embodiments of the present invention will be described with reference to the accompanying drawings. However, embodiments of the present invention may be modified into various other forms, and the scope of the present invention is not limited to the embodiments described below. In addition, the embodiments of the present invention are provided in order to more completely explain the present invention to those of ordinary skill in the art.

### Composite

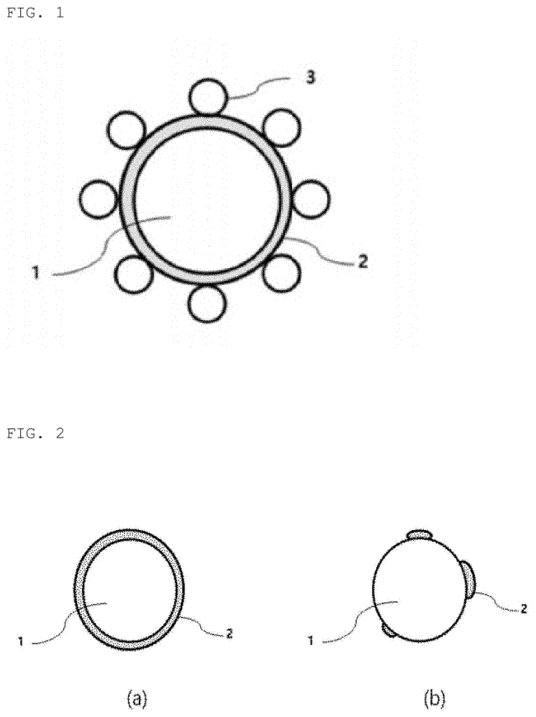

FIG. 1 to FIG. 3 illustrate a composite according to an embodiment of the present invention.

Referring to FIG. 1 to FIG. 3, a composite according to an embodiment of the present invention includes a base powder, an adhesive disposed on the surface of the base powder, and functional particles disposed on the adhesive, wherein the adhesive includes at least one of a fatty primary monoamide and a fatty secondary monoamide.

The base powder is not particularly limited, and may be a metal powder or a non-metal powder, or a mixed powder of a metal powder and a non-metal powder. In one example, the base powder may be a magnetic body, and may be any one of iron, stainless steel, titanium, ferrite, and tungsten, or an alloy including one or more thereof. In addition, the base powder may be a ceramic powder of alumina, silica, silicon carbide, kaolin, titania, or the like, and may be a polymer powder of polyethylene, nylon, or the like. An average diameter of the base powder may be several μm to several mm, and preferably, may be 1 to 500 μm. When the average diameter of the base powder is smaller than 1 μm, the adhesive may not be evenly applied on the surface of the base powder, and there may be a problem in that the base powder aggregates. When the average diameter of the base powder is larger than 500 μm, an excessive molding pressure may be required when using a composite, and when applied to powder metallurgy, there may be a problem in that a sintering temperature is required to be increased.

The functional particles are not particularly limited, and may be metal particles or non-metal particles, or mixed particles of metal particles and non-metal particles. The functional particles may have various shapes, such as a circular shape, a plate shape, a pellet shape, and the like, and the shape thereof is not particularly limited.

The functional particles may be made of a heterogeneous or homogeneous material with the base powder. For example, the base powder and the functional particles may be made of a metal and a non-metal, a metal and a metal, and a non-metal and a metal. In addition, the functional particles may have a size or specific gravity different from that of the base powder. In one example, the functional particles may be any one of iron, stainless steel, titanium, ferrite, and tungsten, or an alloy including one or more thereof. In addition, the functional particles may be ceramic particles of alumina, silica, silicon carbide, kaolin, titania, or the like, and may be polymer particles of polyethylene, nylon, or the like. An average diameter of the functional particles may be several nm to several tens of μm, and may be, if necessary, 500 μm or less, and may be 10 nm to 200 μm. When the average diameter of the functional particles is larger than 500 μm, an excessive molding pressure may be required when using a composite, and when applied to powder metallurgy, there may be a problem in that a sintering temperature is required to be increased. Referring to FIG. 3, functional particles of a certain size may be disposed as shown in (a) and (c), and functional particles of various sizes may be disposed as shown in (b). In addition, functional particles having a size similar to that of the base powder may be disposed as shown in (a).

As described in Example 7, the functional particles may be a composite in which an adhesive is disposed on a base powder and functional particles are disposed on the adhesive. That is, in this case, the composite according to an embodiment of the present invention includes a first base powder, a first adhesive disposed on the surface of the first base powder, and first functional particles disposed on the first adhesive, wherein the first functional particles include a second base powder, a second adhesive disposed on the surface of the second base powder, and second functional particles disposed on the second adhesive, wherein the first adhesive and the second adhesive each include at least one of a fatty primary monoamide and a fatty secondary monoamide. Through the above, a composite with more diverse physical, chemical, and electrical properties may be manufactured, and the composite may be applied to various fields of application.

The adhesive is disposed in at least a portion of the surface of the base powder, and performs a function of stably attaching the base powder and the functional particles. The adhesive may be disposed by being coated or covered on the entire surface of the base powder, or may be disposed partially on the surface of the base powder. When there are many unnecessary adhesives, impurities may remain during a degassing or debinding process, and a heat treatment furnace may be contaminated. Referring to FIG. 2, (a) illustrates that the adhesive is applied on the entire surface of the base powder, and (b) illustrates that the adhesive is applied partially on the surface of the base powder.

The melting point of the adhesive may be 60 to 120° C., more preferably 70 to 100° C. When the melting point of the adhesive is too low, there may be a problem in that decreased adhesion prevents the functional particles from being fixed on the surface of the base powder, and there may be a problem in that the powder aggregates even at room temperature or fluidity of the base powder is disturbed. When the melting point of the adhesive is too high, there may be a problem in that the adhesive is not evenly applied on the surface of the base powder, and in order to solve the problem, there is a difficulty in that a toxic substance such as toluene is used or a process temperature is set excessively high. In this case, when a material with a low melting point is used as the base powder or the functional particles, there may be defects caused by a high process temperature.

The adhesive may include at least one of a fatty primary monoamide and a fatty secondary monoamide. When the adhesive includes a fatty primary monoamide, there is an advantage in that an oxide may be removed by being completely degassed or debound without residual materials in a sintering or heat-treatment process.

When the adhesive includes a fatty primary monoamide, the fatty primary monoamide may be at least one of an unsaturated fatty acid and a saturated fatty acid. In this case, the unsaturated fatty acid may be at least one of oleamide, erucamide, or behenamide. The saturated fatty acid may be at least one of stearamide and palmitamide.

When the adhesive includes a fatty secondary monoamide, the fatty secondary monoamide may be at least one of N-alkyl amide and N-methylol amide. In this case, the N-alkyl amide may be at least one of N-Stearyl erucamide, N-Oleyl stearamide, N-Stearyl oleamide, or N-Stearyl stearamide. N-methylol amide may be N-Methylolstearamide.

Other materials may not be suitable as the adhesive. As an example, paraffin wax, which is a hydrocarbon, has a low melting point, so that powder aggregates even at room temperature, and since fluidity of the powder is poor, there is a problem in that hexane is used as a solvent, so that the paraffin wax is not suitable as a main adhesive. An oleic acid, an erucic acid, and the like, which is a carboxylic acid, also have a low melting point and cause a similar problem. A metal salt and a bis amide have a high melting point, thereby requiring a long heating time and cooling time, have a problem of a high defect rate, and have a problem in that a toxic substance such as toluene or hexane is used as a solvent, and thus are not suitable as a main adhesive.

In a manufacturing method according to an embodiment of the present invention, the adhesive may be supplied in a powder or bead form, but is not particularly limited thereto.

### Manufacturing Method of Composite: Solvent Method

A method for manufacturing a composite according to an embodiment of the present invention includes the steps of: preparing a base powder; dissolving an adhesive in a solvent to prepare an adhesive solution; disposing the adhesive solution on the surface of the base powder; removing the solvent from the adhesive solution to dispose the adhesive on the base powder; and disposing functional particles on the adhesive, wherein the adhesive includes at least one of a fatty primary monoamide and a fatty secondary monoamide.

A method of using a solvent allows an adhesive to be uniformly applied, so that a composite with more excellent quality may be manufactured.

The base powder, the functional particles, and the adhesive may be the same as those described above. The step of preparing a base powder includes preparing the base powder directly or purchasing one.

Next, the step of dissolving an adhesive in a solvent to prepare an adhesive solution is performed.

The solvent is one capable of dissolving an adhesive, and may preferably be a hydroxyl group monohydric alcohol. As an example, the solvent may be any one of methyl alcohol, ethyl alcohol, isopropyl alcohol, isobutyl alcohol, and benzyl alcohol and an allyl alcohol, or a mixture of two or more thereof.

The present step may include a step of heating a mixture of a solvent and an adhesive to dissolve the adhesive in the solvent. At this time, the heating temperature may be higher or lower than the melting point of the adhesive, and preferably, by heating to a temperature lower than the melting point of the adhesive, it is possible to prevent the adhesive from being denatured, and a subsequent crystallization process may be performed more smoothly.

The mixing in the present step may be performed by using a stirrer. As an example, the mixing may be performed by using a general mixer such as a double cone type mixer and a V type mixer, a high speed mixer, an agitator, a kneader machine, an attritor, and the like, may be used.

Next, the step of disposing the adhesive solution on the surface of the base powder is performed.

The present step may be performed by adding the base powder to the adhesive solution, or pouring the adhesive solution into the base powder. In addition, the present step may be performed by spraying a certain amount of the adhesive solution to the base powder using a spray.

Prior to performing the present step, the method may further include a step of heating the base powder. A heating temperature of the base powder may be from 40° C. to a temperature below the melting point of the adhesive, preferably from 50° C. to the temperature below the melting point of the adhesive. By heating the base powder in the present step, it is possible to prevent the adhesive from being crystallized due to an instantaneous temperature drop when the base powder is mixed with the adhesive solution. When the adhesive is crystallized without being sufficiently mixed, the adhesive may not be evenly disposed on the surface of the base powder. When the heating temperature is low, the adhesive may be crystallized, and when the heating temperature is too high, the adhesive may be denatured. In the present step, more preferably in the step of preparing an adhesive solution, the base powder may be heated to a temperature equal to or higher than the temperature at which the solvent and the adhesive are heated. Through the above, it is possible to prevent the temperature of the adhesive solution from decreasing to more effectively prevent the crystallization.

Next, the step of removing the solvent from the adhesive solution to dispose the adhesive on the base powder is performed.

The present step may include a step of heating the adhesive solution to a temperature equal to or lower than the melting point of the adhesive to crystallize the adhesive.

In the present step, the solvent may be removed by drying the adhesive solution, but preferably, the solvent may be rapidly removed by heating the adhesive solution disposed on the surface of the base powder. At this time, it is preferable that a heating temperature is set to a temperature lower than the melting point of the adhesive. If the adhesive solution is heated to a temperature higher than the melting point of the adhesive, the adhesive may flow down so that the base powder aggregates or the adhesive is not evenly disposed on the surface of the base powder, and impurities may remain. In addition, the crystallization of the adhesive may be disturbed.

In the present step, it is possible to control a particle size of the crystallized adhesive according to the content of the solvent. The smaller the particle size of the adhesive, the more uniformly dispersed the base powder, and more evenly disposed a functional powder. Table 1 below illustrates a dissolution temperature and a crystallization temperature according to the content of each of the solvent and the adhesive. In the table below, the dissolution temperature is a temperature at which the adhesive is completely dissolved in the solvent, and the crystallization temperature is a temperature at which adhesive particles start to crystallize in the adhesive solution.

TABLE 1

| | | Adhesive:Solvent | Dissolution | Crystallization |
|---|---|---|---|---|
| | | content ratio | temperature | temperature |
| Adhesive | Solvent | (wt %) | (° C.) | (° C.) |
| Oleamide | Isopropyl alcohol | 1:1 | 44.5 | 38.5 |
| (Oleamide) | (Isopropyl alcohol) | 1:2 | 43.2 | 36.0 |
| | | 1:3 | 41.5 | 34.0 |
| | | 1:4 | 38.5 | 30.5 |
| | | 1:5 | 36.0 | 26.0 |
| | Ethyl alcohol | 1:1 | 42.5 | 38.0 |
| | (Ethyl alcohol) | 1:2 | 40.0 | 33.0 |
| | | 1:3 | 37.0 | 31.0 |
| | | 1:4 | 34.2 | 27.2 |
| | | 1:5 | 32.0 | 23.0 |
| Erucamide | Isopropyl alcohol | 1:1 | 49.0 | 46.0 |
| (Erucamide) | (Isopropyl alcohol) | 1:2 | 45.0 | 42.0 |
| | | 1:3 | 43.0 | 37.0 |
| | | 1:4 | 42.0 | 36.0 |
| | | 1:5 | 41.0 | 34.0 |
| | Ethyl alcohol | 1:1 | 51.0 | 49.0 |
| | (Ethyl alcohol) | 1:2 | 47.0 | 41.0 |
| | | 1:3 | 45.0 | 38.0 |
| | | 1:4 | 44.0 | 37.0 |
| | | 1:5 | 43.0 | 36.0 |
| Stearamide | Isopropyl alcohol | 1:1 | 64.5 | 63.5 |
| (Stearamide) | (Isopropyl alcohol) | 1:2 | 63.0 | 61.0 |
| | | 1:3 | 62.2 | 59.0 |
| | | 1:4 | 61.8 | 55.0 |
| | | 1:5 | 61.6 | 53.0 |
| | Ethyl alcohol | 1:1 | 67.8 | 65.5 |
| | (Ethyl alcohol) | 1:2 | 66.5 | 62.0 |
| | | 1:3 | 64.8 | 59.0 |
| | | 1:4 | 63.8 | 56.0 |
| | | 1:5 | 63.5 | 55.5 |

Next, the step of disposing functional particles on the adhesive is performed. After the solvent is removed and the adhesive is crystallized, functional particles may be attached on the surface of the adhesive. The functional particles may be poured onto the base powder having the adhesive disposed on the surface thereof and then stirred to allow the functional particles to be evenly attached. The present step may include a step of heating a composite of the base powder, the adhesive, and the functional particles to a temperature lower than the melting point of the adhesive. Through the above, the adhesive may have increased adhesion, and the functional particles may be more uniformly disposed. The heating may be performed by a method of applying heat to a container from the outside, or applying heat to an upper portion of the composite. In addition, the heating may be performed by using frictional heat generated during the stirring.

Next, the method may further include a step of stirring, while cooling, the heated composite of the base powder, the adhesive, and the functional particles.

### Manufacturing Method of Composite: Friction Method

A method for manufacturing a composite according to another embodiment of the present invention includes the steps of: mixing a base powder and an adhesive; and generating frictional heat between the base powder and the adhesive, wherein the adhesive includes at least one of a fatty primary monoamide and a fatty secondary monoamide.

The base powder, the functional particles, and the adhesive may be the same as those described above.

In the step of mixing a base powder and an adhesive, functional particles may be further mixed. The functional particles may be added after the base powder and the adhesive are mixed, or may be added simultaneously with the base powder and the adhesive.

Next, the step of generating of frictional heat between the base powder and the adhesive is performed. The present step may be performed by adding the mixture to a stirrer and then stirring the mixture. When the base powder, the adhesive, and the functional powder are mixed, mechanical friction occurs, and the mixture may be heated by frictional heat generated at the time. The frictional heat generated in the present step heats the mixture to a temperature range lower than the melting point of the adhesive, through which the functional particles may be evenly and stably fixed on the surface of the base powder.

When the functional particles are previously mixed, frictional heat is generated between the base powder, the adhesive, and the functional particles. If the functional particles are not added in the previous step, the functional particles may be added in the present step. By adding the functional particles after the base powder and the adhesive are mixed, it is possible to evenly dispose the functional particles on the surface of the base powder. In addition, it is possible to prevent aggregation or segregation of the powder and the particles. To this end, the functional powder may be added after generating frictional heat by stirring the base powder and the adhesive, thereby evenly disposing the adhesive on the surface of the base powder. To this end, in the step of stirring the base powder and the adhesive, the mixture may be heated to a temperature lower than the melting point of the adhesive. Next, the functional particles may be added and then stirred to generate frictional heat so as to evenly dispose the functional particles on the surface of the base powder. Also in the present step, by heating the mixture of the base powder, the adhesive, and the functional particles to a temperature lower than the melting point of the adhesive, it is possible to increase processing efficiency and prevent the occurrence of defects.

Next, a step of cooling the mixture may be performed. In the present step, the mixture may be continuously stirred to be mixed, and preferably, the mixture may be mixed up to room temperature to manufacture a composite of excellent quality.

### Manufacturing Method of Composite: Dissolution Method

A method for manufacturing a composite according to an embodiment of the present invention includes the steps of: preparing a base powder; heating an adhesive to a temperature equal to or higher than the melting point thereof; disposing the adhesive on the surface of the base powder; and disposing functional particles on the adhesive, wherein the adhesive includes at least one of a fatty primary monoamide and a fatty secondary monoamide.

The base powder, the functional particles, and the adhesive may be the same as those described above.

In the step of heating an adhesive to a temperature equal to or higher than the melting point thereof, the adhesive is melted and becomes in a liquid state.

The step of disposing the adhesive on the surface of the base powder may be performed by pouring the melted adhesive onto the base powder, spraying the melted adhesive using a spray, or immersing the base powder in the melted adhesive.

The present step may further include a step of mixing the base powder and the adhesive by stirring.

Next, the step of disposing functional particles on the adhesive is performed.

The present step may be performed by adding functional particles to the mixture of the base powder and the adhesive, and then stirring the same.

Next, the present step may include a step of heating the adhesive to a temperature equal to or lower than the melting point of the adhesive. The present step may be performed by heating a container in which the mixture of the base powder, the adhesive, and the functional powder is immersed, or by heating the mixture. Through the present step, adhesion of the adhesive may be reinforced to allow the functional particles to be strongly bonded to the surface of the base powder.

Next, a step of cooling the mixture may be performed. In the present step, the mixture may be continuously stirred to be mixed, and preferably, the mixture may be mixed up to room temperature to manufacture a composite of excellent quality.

### EXAMPLE 1

100 parts by weight of Pometon Company's iron alloy powder ‘Feralloy Cr8’ (base powder), and 1.5 parts by weight of PMC Biogenix Company's erucamide ‘Armoslip E’ (adhesive) were prepared. The erucamide was added to 4.5 parts by weight of ethyl alcohol (solvent) and put into a stainless steel bottle, and then heated to 50° C. to prepare an erucamide solution. Next, the base powder was heated to 50° C. Through the heating process, when the erucamide solution is added, it is possible to prevent the erucamide solution from being crystallized due to a rapid decrease in the temperature caused by the contact with the base powder. The heated base powder was charged into a double cone mixer, and the erucamide solution was added thereto, and the mixture was mixed and cooled until the ethyl alcohol was completely removed to prepare a composite.

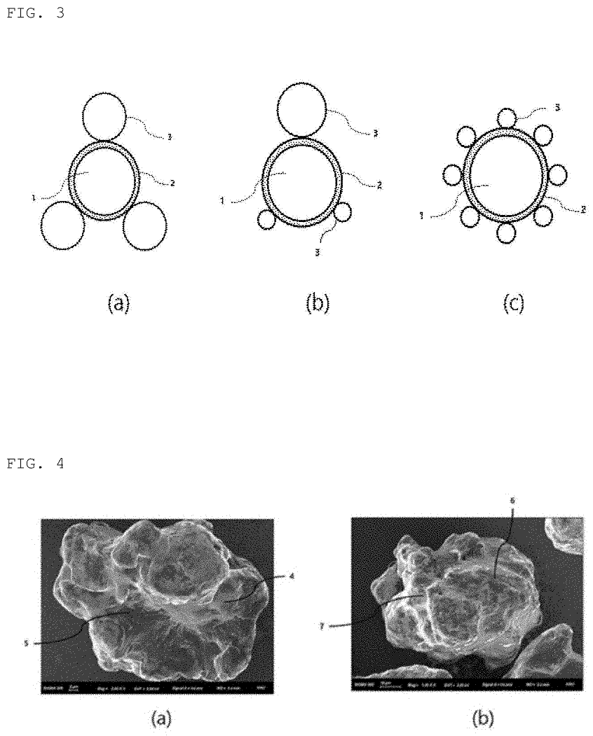

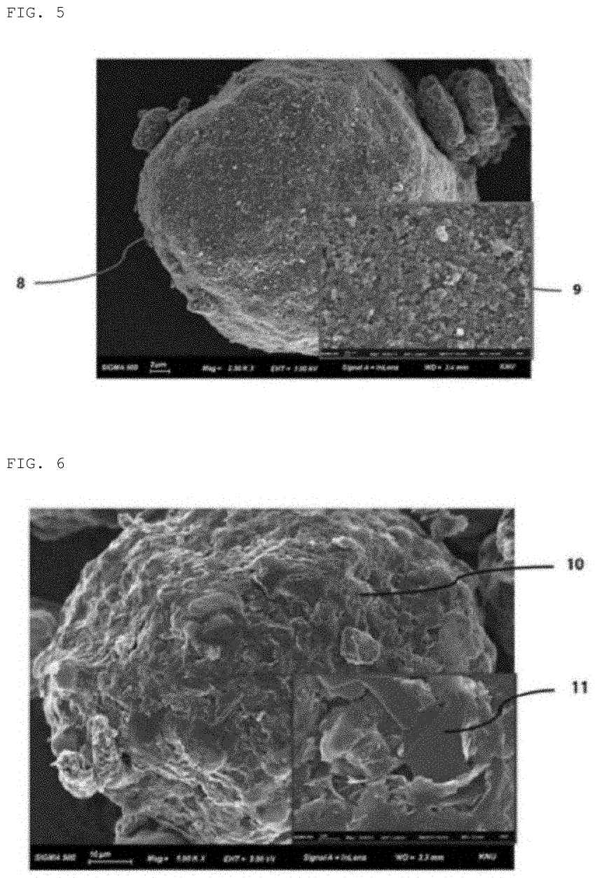

FIG. 4(a) is the composite of Example 1 photographed using a SIGMA 500 (a low voltage field emission scanning electron microscope (FE-SEM)) manufactured by Carl ZEISS of Germany. The light portion is the base powder (4), and the dark portion is the adhesive, that is, erucamide (5).

### EXAMPLE 2

100 parts by weight of Hoganas Company's iron alloy powder ‘Astaloy CrM’ (base powder), and 1 part by weight of PMC Biogenix Company's stearamide (adhesive) ‘Armoslip HT’ were prepared. The stearamide was added to 5 parts by weight of isopropyl alcohol (solvent) and put into a stainless steel bottle, and then heated to 50° C. to prepare a stearamide solution. Next, the base powder was heated to 50° C. Through the heating process, when the stearamide solution is added, it is possible to prevent the stearamide solution from being crystallized due to a rapid decrease in the temperature caused by the contact with the base powder. The heated base powder was charged into an attritor, and while the heated base powder was being stirred, the stearamide solution was sprayed with a spray. After the spraying was completed, the stirring was continued until the solvent was evaporated and thereby removed.

FIG. 4(b) is the composite of Example 2 photographed using a SIGMA 500 (a low voltage field emission scanning electron microscope (FE-SEM)) manufactured by Carl ZEISS of Germany. The light portion is the base powder (6), and the dark portion is the adhesive (7).

### EXAMPLE 3

97.6 parts by weight of Pometon Company's iron alloy powder ‘Feralloy Cr4’ (base powder), 2.4 parts by weight of Birla carbon Company's carbon black (functional particles) ‘Raven 1010,’ 0.72 parts by weight of ‘Armoslip E’ (adhesive), and 1.44 parts by weight of isopropyl alcohol (solvent) were prepared. The adhesive and the solvent were charged into an attritor, and then heated to 45° C. to prepare an adhesive solution. Thereafter, the base powder heated to 45° C. was added thereto and mixed. After 20 minutes, it was confirmed that the solvent was removed, and then the functional particles were added to the mixture. The mixture was heated to 60° C. while being stirred until the functional particles were completely adhered on the surface of the base powder, and then stirred until the temperature reached 40° C. Thereafter, the stirring was stopped and the mixture was slowly cooled.

FIG. 5 is the composite of Example 3 photographed using a SIGMA 500 (a low voltage field emission scanning electron microscope (FE-SEM)) manufactured by Carl ZEISS of Germany. The base powder (8) and the functional powder (9) were confirmed.

### EXAMPLE 4

99.2 parts by weight of Rio Tinto Metal Powders Company's ‘Atomet 1001’ pure iron powder (base powder), 0.8 parts by weight of Standard Graphene Company's ‘rGO-V50’ graphene (functional particles), 0.24 parts by weight of Croda Company's Incroslip C′ (adhesive), and 0.96 parts by weight of isopropyl alcohol (solvent) were prepared. The solvent and the adhesive were added to a stainless steel bottle and heated to 50° C. to prepare an adhesive solution. The base powder was charged into an attritor and while the base powder was being stirred, and the adhesive solution was sprayed using a spray. After the spraying was completed, the stirring was continued until the solvent was removed. After the solvent was removed, the functional particles were added and stirred slowly to be mixed. At this time, heating was performed to 60° C. to allow the functional particles to be well adhered, and after the addition of the functional particles was completed, the temperature was maintained at 60° C. for 10 minutes, and then the heating was stopped. Thereafter, the stirring rate was slowly reduced until the temperature reached 40° C., and when the temperature reached 40° C., the stirring was stopped and the mixture was slowly cooled.

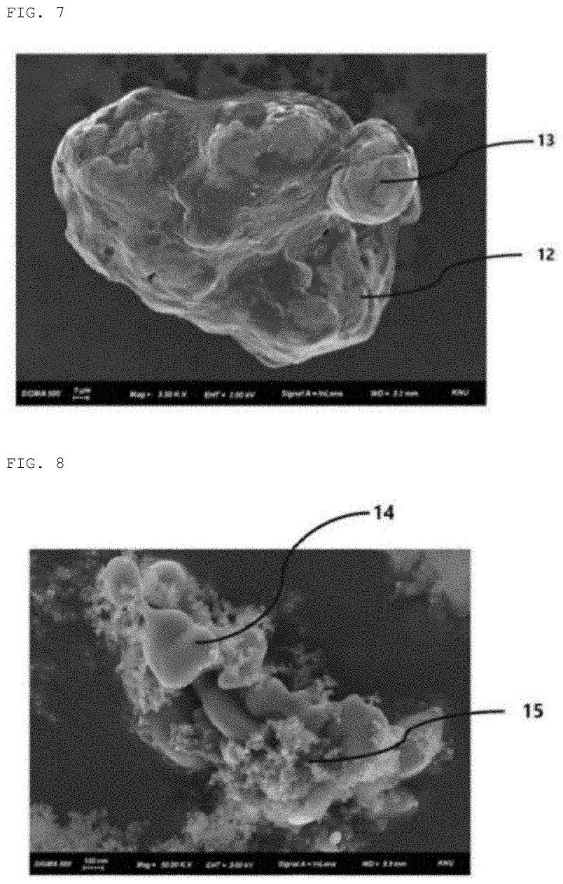

FIG. 6 is the composite of Example 4 photographed using a SIGMA 500 (a low voltage field emission scanning electron microscope (FE-SEM)) manufactured by Carl ZEISS of Germany. The base powder (10) and the functional powder (11) were confirmed.

### EXAMPLE 5

80 parts by weight of Rio Tinto Metal Powders Company's ‘Atomet 1001’ pure iron powder (base powder), 20 parts by weight of Poongsan Holdings Company's ‘CUI-325’ (functional particles), and 1 part by weight of ‘Armoslip HT’ (adhesive) were prepared. The base powder was charged into an attritor and stirred while being heated to 70° C. Thereafter, the adhesive was added and stirred so that the adhesive was applied on the surface of the base powder. When the adhesive in a powder form was not visually confirmed, the functional particles were added and stirred to be mixed. The heating was stopped and the mixture was slowly mixed until the temperature reached 40° C., and then naturally cooled.

FIG. 7 is the composite of Example 5 photographed using a SIGMA 500 (a low voltage field emission scanning electron microscope (FE-SEM)) manufactured by Carl ZEISS of Germany. The base powder (12) and the functional powder (13) were confirmed.

### EXAMPLE 6

95 parts by weight of EG Company's ‘SKM-2T’ iron oxide powder (base powder) having an average diameter of 1 μm or less, 5 parts by weight of Evonik Company's ‘Aerosil R202’ (functional particles) as fumed silica having an average diameter of 50 nm, 2.5 parts by weight of ‘Armoslip E’ erucamide (adhesive), and 10 parts by weight of isopropyl alcohol (solvent) were prepared. The solvent and the adhesive were charged into an attritor, and then heated to 45° C. to prepare an adhesive solution. The base powder heated to 50° C. was added thereto and stirred so that the adhesive solution was applied on the surface of the base powder. After it was confirmed that the solvent was removed, the functional particles were added. At this time, heating was performed to 60° C. to allow the functional particles to be well adhered, and thereafter, stirring was performed until the temperature reached 40° C. When the temperature reached 40° C., the stirring was stopped and the mixture was slowly cooled.

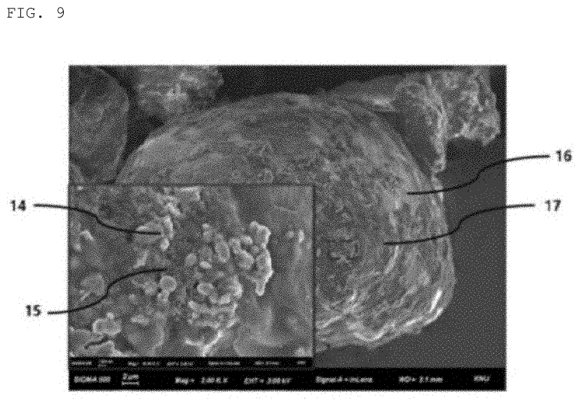

FIG. 8 is the composite of Example 6 photographed using a SIGMA 500 (a low voltage field emission scanning electron microscope (FE-SEM)) manufactured by Carl ZEISS of Germany. The base powder (14) and the functional powder (15) were confirmed.

### EXAMPLE 7

95 parts by weight of Hoganas Company's ‘Astaloy CrM’ (base powder), 5 parts by weight of the composite (functional particles) manufactured in Example 6, 1.2 parts by weight of Croda Company's ‘Incroslip C’ erucamide (adhesive 1), and 0.3 parts by weight of PMC Biogenix Company's ‘Armoslip CP’ oleamide (adhesive 2) were prepared. The adhesives 1 and 2 were charged into a stainless steel bottle and heated to 90° C. so that the adhesives were dissolved. The base powder was charged into an attritor, and then the dissolved adhesives were sprayed with a spray and mixed. The dissolved adhesive was evenly applied on the base powder and mixed slowly until the temperature reached 60 ° C. Thereafter, the functional particles were added thereto and mixed. After the functional particles were evenly applied on the base powder, the heating was stopped and the mixture was mixed while being cooled to 40° C., and then naturally cooled.

FIG. 8 is the composite of Example 7 photographed using a SIGMA 500 (a low voltage field emission scanning electron microscope (FE-SEM)) manufactured by Carl ZEISS of Germany. The base powder (16), the adhesive (17), the base powder (14) of functional powder, and the functional powder (15) were confirmed.

Table 2 shows the conditions of Examples 1 to 7.

TABLE 2

| | Base powder | | | Functional particles | | | Adhesive | | |
|---|---|---|---|---|---|---|---|---|---|
| | | Manufacturer/ | | | Manufacturer/ | | Manufacturer/ | | |
| Mixed | | Product | Powder | | Product | Powder | Product | | Manufacturing |
| powder | Classifications | name | size | Classifications | name | size | name | Solvent | method |
| Example | Metal | Pometon/ | Iron | — | — | — | PMC | Ethyl | Solvent |
| 1 | | Feralloy | alloy | | | | Biogenix/ | alcohol | method |
| | | Cr8 | powder | | | | Armoslip | | |
| | | | 150 μm | | | | E | | |
| | | | or less | | | | | | |
| Example | Metal | Hoganas/ | Iron | — | — | — | PMC | Isopropyl | Solvent |
| 2 | | Astaloy | alloy | | | | Biogenix/ | alcohol | method |
| | | CrM | powder | | | | Armoslip | | (Spraying) |
| | | | 150 μm | | | | HT | | |
| | | | or less | | | | | | |
| Example | Metal | Pometon/ | Iron | Non-metal | Birla carbon/ | Carbon | PMC | Isopropyl | Solvent |
| 3 | | Feralloy | alloy | | Raven | black | Biogenix/ | alcohol | method |
| | | Cr4 | powder | | 1010 | 200 nm or | Armoslip | | |
| | | | 150 μm | | | less | E | | |
| | | | or less | | | | | | |
| Example | Metal | Rio | Pure | Non-metal | Standard | Graphene | Croda/ | Isopropyl | Solvent |
| 4 | | Tinto/ | iron | | Graphene/rGO- | Lateral (x, | Incroslip | alcohol | method |
| | | Atomet | powder | | V50 | y) ≥30 μm | C | | |
| | | 1001 | 180 μm | | | Through- | | | |
| | | | or less | | | plane (z) | | | |
| | | | | | | 1.0~1.4 nm | | | |
| Example | Metal | Rio | Pure | Metal | Poongsan/ | Copper | PMC | — | Friction |
| 5 | | Tinto/ | iron | | CUI-325 | pure | Biogenix/ | | method |
| | | Atomet | powder | | | powder | Armoslip | | |
| | | 1001 | 250 μm | | | 45 μm or | HT | | |
| | | | or less | | | less | | | |
| Example | Non- | EG/SKM- | Iron | Non-metal | Evonik/ | Fumed | PMC | Isopropyl | Solvent |
| 6 | metal | 2T | oxide | | Aerosil | silica | Biogenix/ | alcohol | method |
| | | | powder | | R202 | 50 nm or | Armoslip | | |
| | | | 1 μm or | | | less | E | | |
| | | | less | | | | | | |

| | | | | | | | | |
|---|---|---|---|---|---|---|---|---|
| Example | Metal | Hoganas/ | Iron | Non-metal | Mixed powder prepared in | Croda/ | — | Dissolution |
| 7 | | Astaloy | alloy | | Example 6 | Incroslip | | method |
| | | CrM | powder | | | C + PMC | | |
| | | | 150 μm | | | Biogenix/ | | |
| | | | or less | | | Armoslip | | |
| | | | | | | CP | | |

1. A composite comprising:
a base powder;
an adhesive disposed on the surface of the base powder;
and functional particles disposed on the adhesive,
wherein the adhesive includes at least one of oleamide and erucamide.

2. The composite of claim 1, wherein the adhesive has a melting point of 120° C. or less.

3. A method for manufacturing a composite, the method comprising the steps of:
preparing a base powder;
dissolving an adhesive in a solvent to prepare an adhesive solution;
disposing the adhesive solution on the surface of the base powder;
removing the solvent from the adhesive solution to dispose the adhesive on the base powder; and
disposing functional particles on the adhesive,
wherein:
the adhesive includes at least one of a fatty primary monoamide and a fatty secondary monoamide; and
the step of disposing functional particles on the adhesive includes a step of heating the adhesive to a temperature equal to or lower than the melting point of the adhesive.

4. A method for manufacturing a composite, the method comprising the steps of:
mixing a base powder and an adhesive;
generating frictional heat between the base powder and the adhesive; and
disposing functional particles on the adhesive,
wherein the adhesive includes at least one of oleamide and erucamide.

5. A method for manufacturing a composite, the method comprising the steps of:
mixing a base powder, an adhesive, and a functional powder; and
generating frictional heat between the base powder and the adhesive to dispose functional particles on the adhesive,
wherein the adhesive includes at least one of oleamide and erucamide.

6. A method for manufacturing a composite, the method comprising the steps of:
preparing a base powder;
heating an adhesive to a temperature equal to or higher than the melting point thereof;
disposing the adhesive on the surface of the base powder; and
disposing functional particles on the adhesive,
wherein the adhesive includes at least one of oleamide and erucamide.

7. A method for manufacturing a composite, the method comprising the steps of:
preparing a base powder, an adhesive, and functional particles;
heating the adhesive to a temperature equal to or higher than the melting point thereof; and
mixing the base powder, the adhesive, and the functional particles to dispose the adhesive on the surface of the base powder and to dispose the functional particles on the adhesive,
wherein the adhesive includes at least one of oleamide and erucamide.
